(19) United States
(12) Patent Application Publication
(10) Pub. No.: US 2018/0203826 A1
(43) Pub. Date: Jul. 19, 2018

(54) SYSTEM AND METHOD FOR GENERATING WEB PAGE LAYOUTS

(71) Applicant: Go Daddy Operating Company, LLC, Scottsdale, AZ (US)

(72) Inventor: Jason Ansel, Seattle, WA (US)

(21) Appl. No.: 15/408,996

(22) Filed: Jan. 18, 2017

(51) Int. Cl. G06F 17/21; G06F 3/0482; G06F 17/22

(52) U.S. Cl. CPC G06F 17/212; G06F 3/0482; G06F 17/218; G06F 17/2247; G06F 17/2294

(57) ABSTRACT

A system and method for generating web page layouts is presented. A computer server is configured to retrieve blocks of text for a web page. Each block of text is rendered into columns of text. A presentation score is calculated for each column of text. Populated web page layouts are generated for each web page layout in a plurality of web page layouts by determining a number of columns in the web page layout, for each block of text, positioning a rectangle having the same width and height as one of the plurality of columns of text for each block of text into a column in the web page layout to generate a populated web page layout, and calculating, without user input, a rendering score for the populated web page layout. One of the populated web page layouts is used to render a web page.

### FIELD OF THE INVENTION

The present disclosure generally relates to web site content processing, and more specifically, to systems and methods for analyzing and processing web page content to generate web page layouts.

### BACKGROUND OF THE INVENTION

The Internet comprises a vast number of computers and computer networks that are interconnected through communication links. The interconnected computers exchange information using various services. In particular, a server computer system, referred to herein as a web server or computer server, may connect through the Internet to a remote client computer system, referred to herein as a requesting device. The requesting device may request and receive, from the web server, web sites containing one or more graphical and textual web pages of information. A request is made by visiting the web site's address, known as a Uniform Resource Locator (“URL”). Upon receipt, the requesting device can display the web pages. The request and display of the web site's content are typically conducted using a browser. A browser is a special-purpose application program that effects the requesting of web pages and the displaying of web page content.

The information on web pages is in the form of programmed source code that the browser interprets to determine what to display on the requesting device. The source code may include document formats, objects, parameters, positioning instructions, and other code that is defined in one or more web programming or markup languages. One web programming language is HyperText Markup Language (“HTML”), and all web pages may use it to some extent. HTML uses text indicators called tags to provide interpretation instructions to the browser. The tags specify the composition of design elements such as text, images, shapes, hyperlinks to other web pages, programming objects such as JAVA applets, form fields, tables, and other elements. By default, the browser processes HTML instructions in the order they are listed, so that elements appear on the web page according to the HTML processing flow. HTML can be used to establish design element positioning in combination with Cascading Style Sheets (“CSS”) or a number of other technologies to ascribe either a relative or an absolute position of the element on the web page, as depicted on the requesting device. Relative positioning of an element retains the element within the HTML processing flow, moving the element a proscribed number of pixels horizontally or vertically away from the place the element otherwise would have appeared. In contrast, absolute positioning places the element a proscribed number of pixels from the top-left (or top-right in countries with right-to-left reading direction) corner of the web page.

When constructing a web site, many users, rather than directly write the code that makes up the web site, use tools that assist in the design and construction of the web site. These tools, sometimes referred to as web site builders, allow for the construction of web sites without manual code editing. The tools usually provide what-you-see-is-what-you-get (WYSIWYG) interfaces enabling the users to construct web sites by dragging and placing different content, such as text, images, video, and the like, directly onto a webpage. As the user constructs their web site using the web site builder's interfaces, the structure of the web pages being constructed is saved. After the user has finished constructing their web site using the web site builder, the user can save the web site and, in some cases, publish the constructed web site to the Internet.

### BRIEF DESCRIPTION OF THE DRAWINGS

FIG. 1 illustrates example content for a web page.

FIG. 2 is a flowchart illustrating a method for generating multiple columns of rendered text for the text content of a web page.

FIGS. 3A-3E depict a number of different renderings of a block of text into different columns.

FIGS. 4A-4E show rectangles generated based upon the columns of text illustrated in FIGS. 3A-3E, respectively.

FIG. 5 is a flowchart illustrating a method for generating and populating web page layouts in accordance with the present disclosure.

FIGS. 6 and 7 are screenshots depicting populated candidate web page layouts.

FIG. 8 is a flowchart depicting a method for iteratively generating scores of layouts in accordance with the present disclosure.

FIG. 9 depicts the evolutionary approach for generating and selecting from multiple generations of populated candidate web page layouts.

FIG. 10 is an illustration of an environment in which the present system for analyzing and generating web site content may be implemented.

FIG. 11 is a block diagram showing a potential implementation of a server included in the environment of FIG. 10.

### DETAILED DESCRIPTION OF THE PREFERRED EMBODIMENT

The present disclosure provides a system and method by which content for a web page of a website may be analyzed and processed to automatically generate a web page layout incorporating that content. The generated web page layout is arranged, as described herein, so that the content is positioned and laid out within the web page layout in an optimized manner. The system and method may be performed by a computer system, such as a hosting web server, computer server, personal computing device, mobile device, or any other computing system, configured to retrieve and analyze web site content.

When constructing a website, a user will generally construct a number of individual web pages that are, to some degree, linked to one another. Each web page of the website will include a certain amount of content, including text, images, multimedia (e.g., video and audio content) and, in some cases, widgets or applications that may be incorporated into the web page. When constructing the web page, either manually or using a tool such as a WYSIWYG web page editor, the user generally adds the content into an existing template or layout. The content may include blocks of text (e.g., paragraphs or other groupings of textual data), images, and other content. When adding the content, the user can select a general location and placement for the content.

When laying out the content of a web page, the layout is an important factor in the experience of an individual reviewing and utilizing the web page. A good layout, for example, may present the web page content in a manner that is balanced (e.g., the web page appears to have some symmetry and does not appear lob-sided). Similarly, a good layout may avoid large areas of white space that do not convey useful information or content as well as paragraphs of text that end with a line containing a single (or “widow”) word. A good layout is generally easier and more pleasant to read and navigate, prompting visitors to the web page to spend more time reviewing the content and navigating the website. In contrast, a website containing web pages having poor layouts (e.g., lots of unused white space, poor symmetry, and poorly-structured paragraphs or blocks of text) can be frustrating to read and navigate, resulting in visitors spending less time on the website.

When a user creates a website using WYSIWYG web page editors, the user is generally limited to adding content to a pre-existing website template, where the template contains a pre-determined number of columns into which the content can be placed. Sometimes, because the layout is pre-determined, there is a high likelihood that the particular layout of columns is not well-suited to the user's actual content. As such, the use of pre-defined column arrangements can often result in some of the layout problems described above.

Some web page editors allow the user to make adjustments to the width and number of columns that may be present within a particular web page template. Although this provides the user with additional flexibility, it does not mean that the task of manually creating a good web page layout becomes trivial. As the user adjusts the characteristics (e.g., width) of one column within the template to improve the layout, changes to that column cause the other columns within the template to change, possibly in a manner that detrimentally affects their layout and, thereby, the overall layout. For example, while adjusting the width of one column in the template to reduce an amount of white space in that column, the configuration of other columns in the layout may also change increasing the amount of white space in those columns.

In short, even when using a web page editor that provides WYSIWYG functionality, it can be difficult for a user to create a web page layout that optimizes the visual attributes of the layout.

The present system, therefore, is configured to automatically generate optimized layouts for web page content. A user first provides a collection of content to be incorporated into the web page. The content usually includes paragraphs of text, as well as headings for the text. In some cases, the content may also include images or other multimedia.

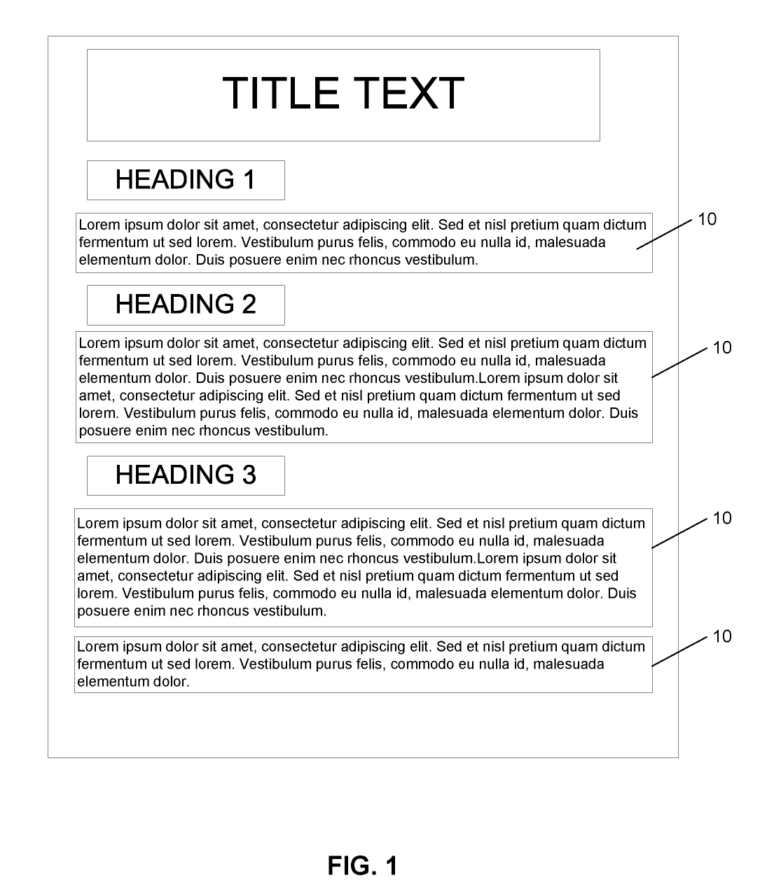

FIG. 1, for example, illustrates example content for a web page. In this example, the content includes a title as well as a number of section headings. Additionally, the content includes a number of blocks of text 10. Blocks of text 10 may be delineated in any suitable manner. For example, blocks of text 10 may include paragraphs of text. If the web page content is encoded as HTML, blocks of text 10 may be delineated by paragraph (e.g., <p> </p>) tags, section (e.g., <section> </section>) tags, or any other suitable tag. Any other suitable approach may be used to delineate blocks of text 10 within the web page content.

With the content provided, the present system identifies each block of text in the content and then processes each block of text in isolation. Specifically, each individual block of text is rendered multiple times as web page content into a number of columns of text having varying widths. The various blocks of text may be rendered using any suitable tool, such as SELENIUM or any other suitable tool for providing testing and analysis of web content rendering. The various columns of rendered blocks of text in the web page content are then used to automatically create a number of different candidate layouts for the web page. In some embodiments, the headings within the web page (e.g., delineated by <H> </H> tag pairs) may be treated like blocks of text 10 and rendered and scored in a similar manner as blocks of text 10, as described below.

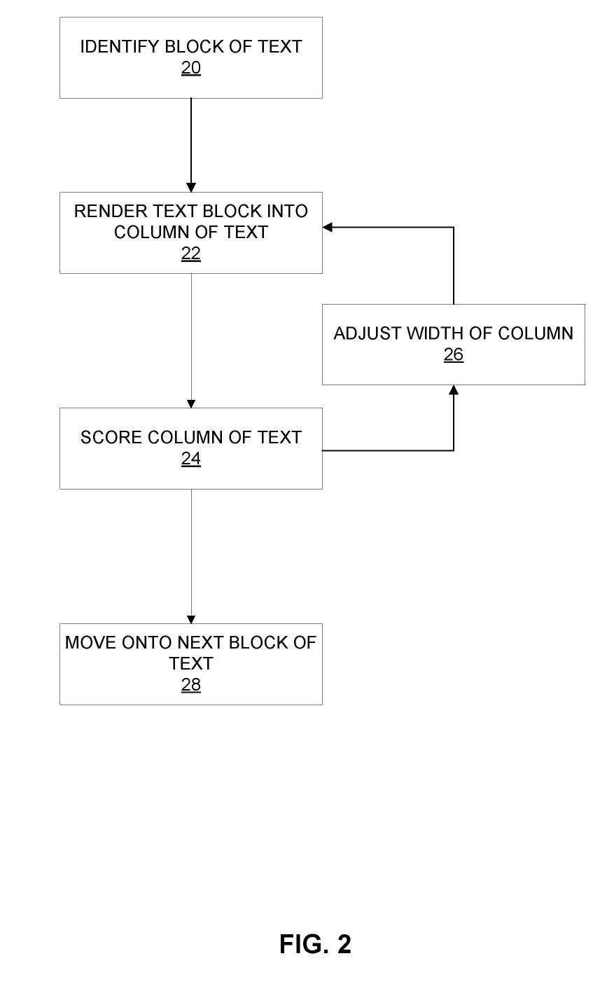

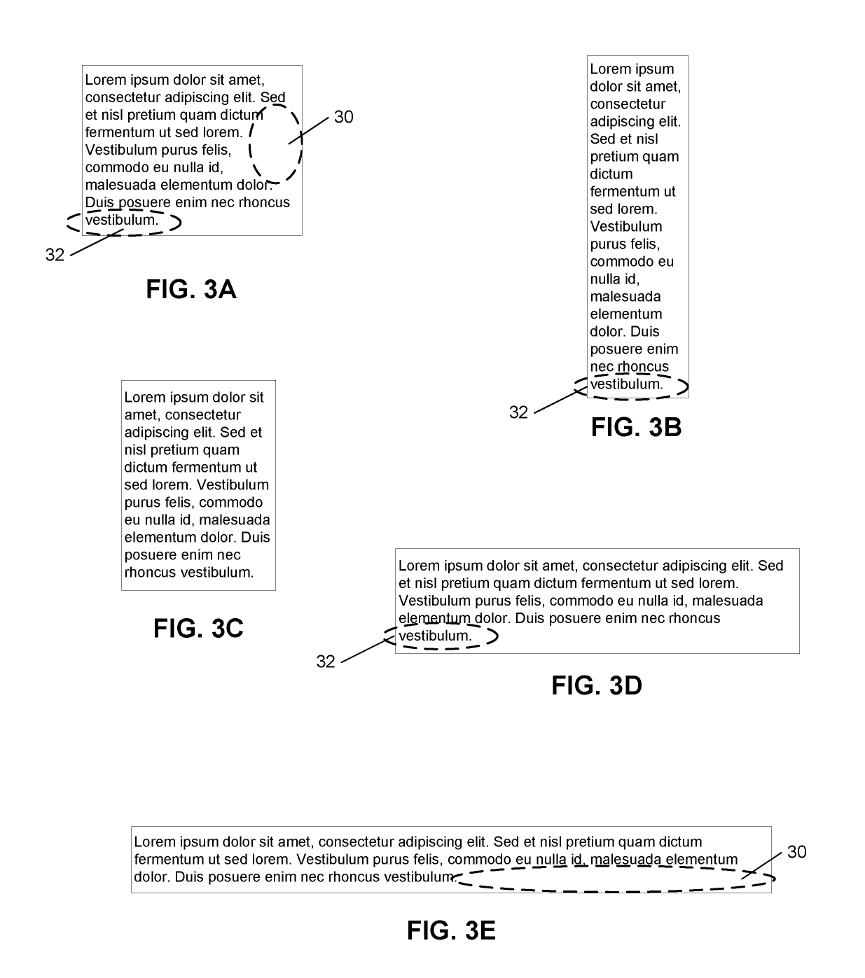

FIG. 2 is a flowchart illustrating a method for generating multiple columns of rendered text for the text content of a web page. In step 20, a block of text 10 is identified in the web page content. As discussed above, any suitable mechanism may be utilized to delineate a block of text in the web page content. Once the block of text is identified, in step 22 the block of text is rendered into a first column of text having a first width. An example of such a rendered block of text is illustrated in FIG. 3A.

After the block of text has been rendered into a column, that column of rendered text is scored in step 24. Each column of text may be scored using any suitable criteria. In one embodiment, each column of text is allocated a score based upon the amount of white space (indicated by dashed circle 30 in FIGS. 3A and 3E) as well as the existence of any widowed words at the end of the text contained within the column (indicated by dashed circle 32 in FIGS. 3A, 3B, and 3D). Following rendering by a suitable tool (e.g., SELENIUM), any suitable approach may be used to score a rendered column of text. For example, JAVASCRIPT scripts may be used to access the document object model (DOM) of the rendered content in order to ascertain the dimensions, and the like, of the rendered content.

If the rendered block of text included heading content, the scoring algorithm for the rendered heading content could apply different scoring criteria than that used to score rendered blocks of text. For example, a penalty associated with wrapping text in a heading onto multiple lines may be much greater than the comparable penalty associated with blocks of text.

After the column has been scored, a different width is selected in step 26 and the block of text is again rendered in step 22 into the column having the different width. Steps 22, 24, and 26 can be repeated many times so that the block of text identified in step 20 is rendered into a large number of different columns having different widths, where each column is allocated a score. For example, FIGS. 3A-3E depict a number of different renderings of a block of text into different columns. In one embodiment, a single block of text may be rendered into about ten different columns, each having a different width, though any number of renderings could be created. In some embodiments, for example, the blocks of text may be rendered into fifty or more different columns of rendered text.

After sufficient columns of rendered text have been generated for the block of text identified in step 20, the method moves to step 28 and a new block of text in the web page content is identified. The method of FIG. 2 will be repeated so that all blocks of text in the web page content are rendered into a large number of different columns of text.

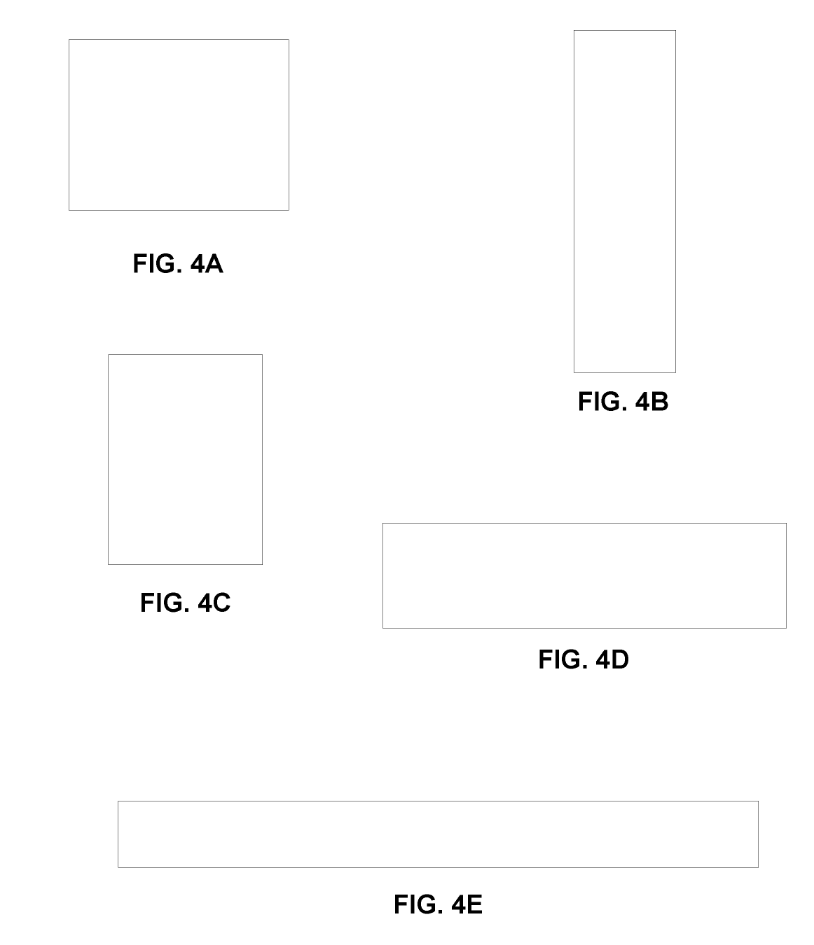

After creating the many different columns of text, each column is converted into a simple rectangle having the same dimensions (e.g., height and width) as that of the column. For example, FIGS. 4A-4E show the rectangles that would be created based upon the columns of text illustrated in FIGS. 3A-3E, respectively. Once the various rectangles have been generated, the present system can rapidly generate new web page layouts by positioning the rectangles within a particular web page layout. Because the rectangles have a fixed and known geometry, they are much simpler to render than corresponding columns of text. That allows the present system to generate a candidate layout using the rectangle in less processing time than it would take another system to generate a candidate layout by rendering the columns of text.

The present system generally operates by creating a number of candidate web page layouts. The candidate web page layouts may be generated randomly, for example by creating a layout that includes a random number of columns each having random widths. Each candidate layout is then populated by rectangles that fit within the candidate layouts. The different candidate layouts containing different combinations of rectangles representative of the text content that will ultimately be incorporated into the web page can then be scored. Based upon the scores, a best layout is selected. The rectangles that were positioned within that candidate layout can then be replaced by the original columns of text that were used to generate the rectangles to generate a web page having an optimized layout.

In some embodiments, as described below, an iterative process may be used. In such an approach, a first generation of candidate layouts is created and populated with the rectangles that represent text content. Each candidate layout in the first generation of candidate layouts can then be scored. When the highest scoring layouts in the first generation of candidate layouts are identified, those highest scoring layouts can be adjusted to generate a new set of candidate layouts (a second generation), which can then be populated with rectangles and rescored. This iterative or evolutionary approach may be utilized to continuously optimize the highest-scoring layouts until an optimized layout is identified.

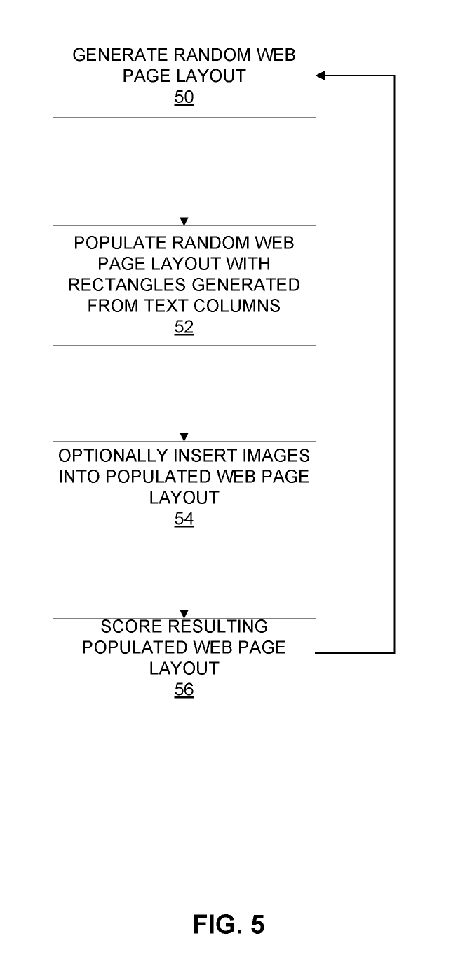

FIG. 5 is a flowchart illustrating a method for generating and populating web page layouts in accordance with the present disclosure. In step 50, the system generates a random web page layout. The web page layout may include a random number of columns, each having a randomly selected width. In one embodiment, a maximum number of columns (e.g., 7) may be implemented, so as to not generate candidate layouts including an unworkable number of columns. As such, the system may be configured to simply generate a number of random layout that are constrained to include a reasonable number of columns, each having reasonable ranges of widths.

After a candidate layout is generated, in step 52 the candidate layout is populated using the rectangles that were generated based on the columns of text created using the method of FIG. 2. Placing the rectangles in the candidate layout involves the system selecting a first rectangle that was generated based upon the first block of text for the web page. The first rectangle is sized to fit within the candidate layout in a first location. Then a second rectangle is selected, where the second rectangle was generated based upon the second block of text for the web page. The second rectangle is sized to fit within the candidate layout in a second location. Then a third rectangle is selected, where the third rectangle was generated based upon the third block of text for the web page. The third rectangle is sized to fit within the candidate layout in a second location. This repeats until a rectangle corresponding to each block of text for the web page has been placed within the candidate layout.

After the candidate layout has been populated with rectangles representing the original text content, in step 54 image content may optionally be inserted into the candidate layout. This may involve, for example, identifying white space or other blank areas within the candidate layout into which image content may be placed. If such whitespace is identified, an image (or another rectangle having the same dimensions as the image) may be inserted into the candidate layout. The amount of white space present within a rendered candidate layout may be determined, for example, using JAVASCRIPT tools in combination with SELENIUM. This may involve, for example, taking a screenshot of the candidate layout, where the area of the candidate layout minus the sum of the areas of the rectangles representing the original text content may be used to determine an amount of white space. Alternatively, a screenshot may be generated of the candidate layout, with the resulting screenshot being automatically analyzed to identify regions of continuous whitespace.

After the candidate layout has been populated with rectangles in step 52 and, optionally, images (or rectangles representing image content) in step 54, the resulting populated web page layout is scored in step 56.

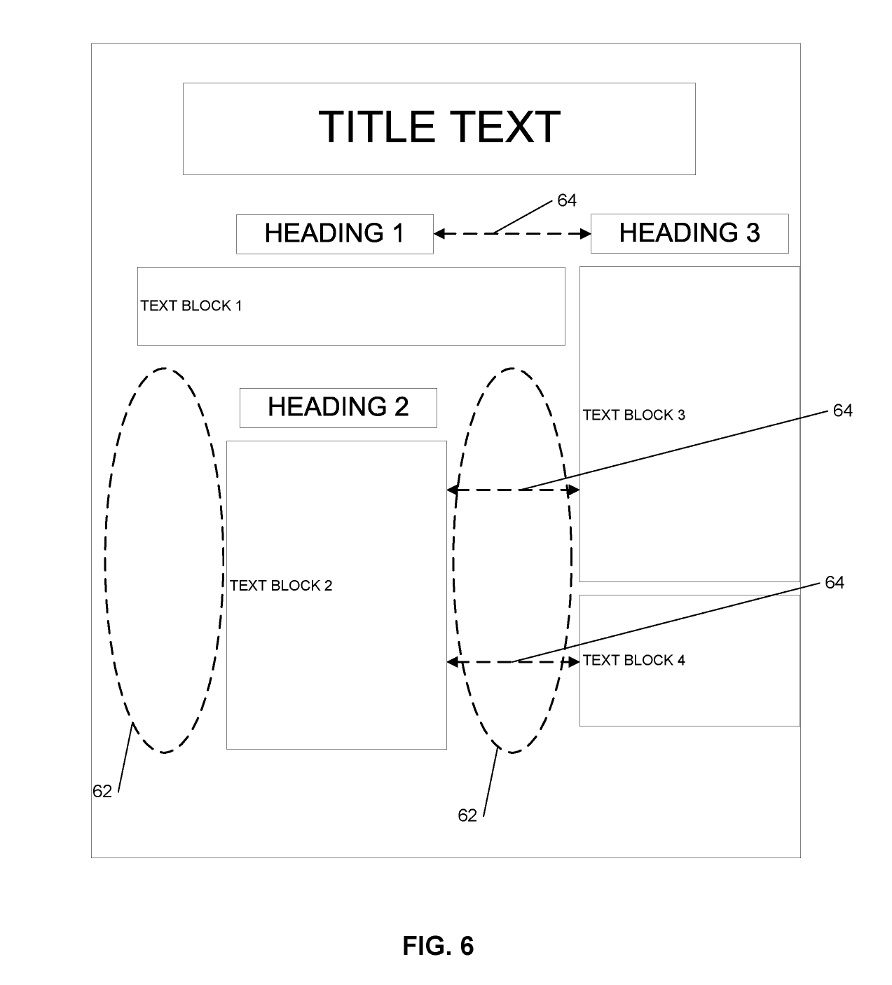

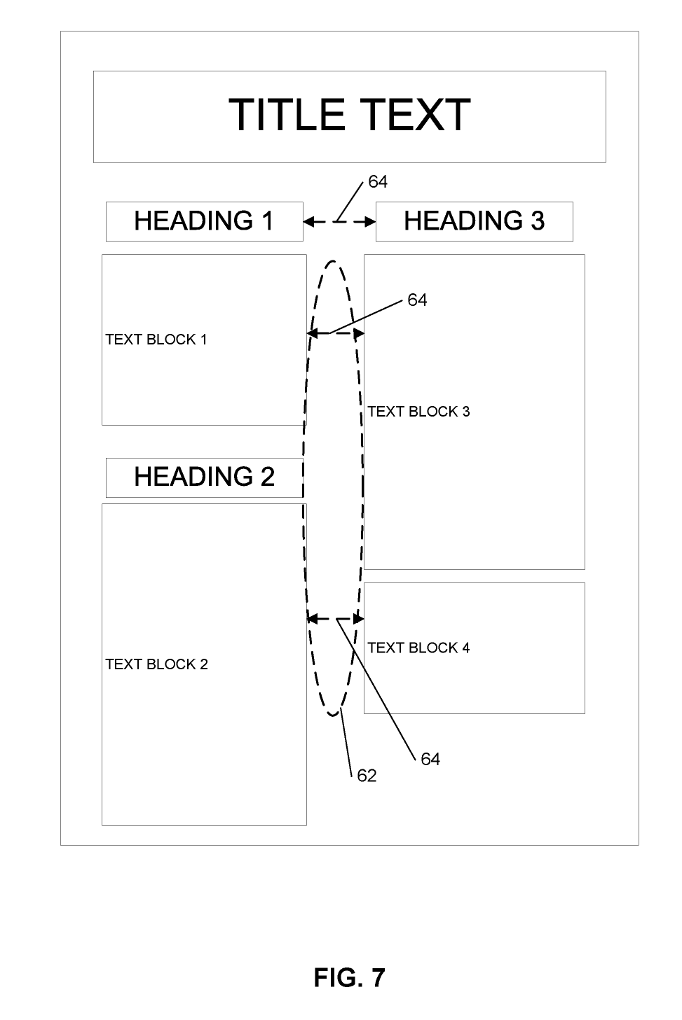

Generally, a populated web page layout may be scored using any criteria. To illustrate, FIGS. 6 and 7 are screenshots depicting populated candidate web page layouts. Once populated, the web page layouts may be scored based upon an amount of whitespace 62 present within the populated web page layout. Generally, the greater the area of whitespace within a candidate web page layout, the lower that layout's score. The populated web page layouts may also be scored based upon a distance 64 between the rectangles appearing in the populated web page layouts (and, thereby, the distances between the columns of text that may ultimately appear in the web page layout). In one embodiment, a preferred range of distances 64 between rectangles may be defined. If a populated web page layout includes rectangles with distances between the rectangles falling outside that preferred range, that populated web page layout may receive a lower score than another populated web page layout in which the distances between the rectangles fall within the preferred range.

In another embodiment, a machine learning engine may be utilized to score the rendered web page layouts. A suitable machine learning algorithm may utilize stochastic optimization algorithms in order to generate and score the candidate web page layouts. The machine learning engine may be configured to process a number of features of each populated web page layout against a body of training data in order to calculate a score for each populated web page layout. Example features that may be utilized by the machine learning engine include a number of columns in each layout as well as the widths of the layouts, an amount of whitespace in each layout, a density of content within the layout (e.g., a ratio of the space in the layout occupied by rectangles to the overall size of the layout), a degree of symmetry (both vertical and horizontal) in the layout, dimensions of the layout, the scores of the individual rectangles included within the populated web page layout, and the like. The symmetry of a populated web page layout may be determined by identifying an amount of content (e.g., a volume of rectangles) falling on one side of a line running vertically through a middle of the populated web page layout versus an amount of content falling on the other side of the line running through the middle of the populated web page layout.

Returning to FIG. 5, after the populated web page layout is scored the method returns to step 50 and another candidate web page layout is generated. The candidate web page layout can then be populated and scored according to the method of FIG. 5.

By repeating the method of FIG. 5 a number of times, a large number of candidate web page layouts can be generated, populated within rectangles representing content, and scored. After the method of FIG. 5 has executed a threshold number of times (e.g., 100 times) and the resulting populated web page layouts scored, the layout having the highest score may simply be identified, re-populated with the original text content, and present to the user as the optimized layout.

In other embodiments, however, an iterative process may be utilized in which the method of FIG. 5 is executed a number of times to generate a first generation of candidate layouts. The highest scoring layouts in that first generation can be adjusted a number of times to generate a new second population of layouts. Those layouts, in turn, can be populated with rectangles and scored and the highest-scoring layouts of the second generation can be identified. In this manner, multiple generations of layouts can be created, populated and scored, with only the highest scoring layouts from one generation being adjusted to create the layouts of the second generation.

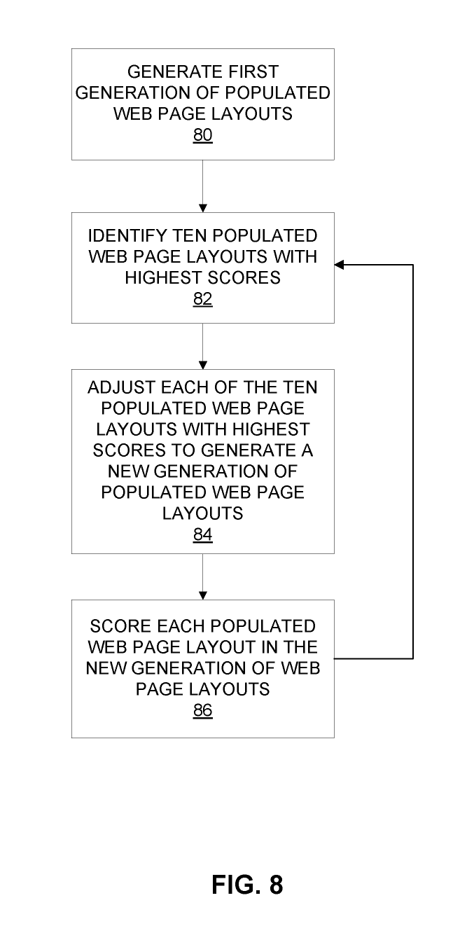

To illustrate, FIG. 8 is a flowchart depicting a method for iteratively generating scores of layouts in accordance with the present disclosure. In step 80, a first generation of populated layouts is created. The populated layouts may be generated, for example, according to the method of FIG. 5. After the first generation of layouts is created and scored, in step 82, the highest-scoring layouts of the first generation are identified. In this example, the ten highest scoring populated web page layouts are identified in step 82, though in other embodiments any number of highest-scoring layouts may be identified.

In step 84, each of the highest scoring populated web page layouts identified in step 82 are adjusted to generate a new generation of web page layouts. This may involve, for example, taking each individual highest scoring web page layout and randomly adjusting or mutating the columns widths in each of the highest scoring web page layouts in a random manner. These mutations may involve adding or removing columns, adjusting column widths, making all columns in a candidate layout the same length, and the like.

When the new generation of layouts has been created, in step 86, each one of the new web page layouts is populated and scored. The method may then repeat, with the highest scoring populated layouts in the new generation being selected and then modified to generate a third generation of layouts, and so on.

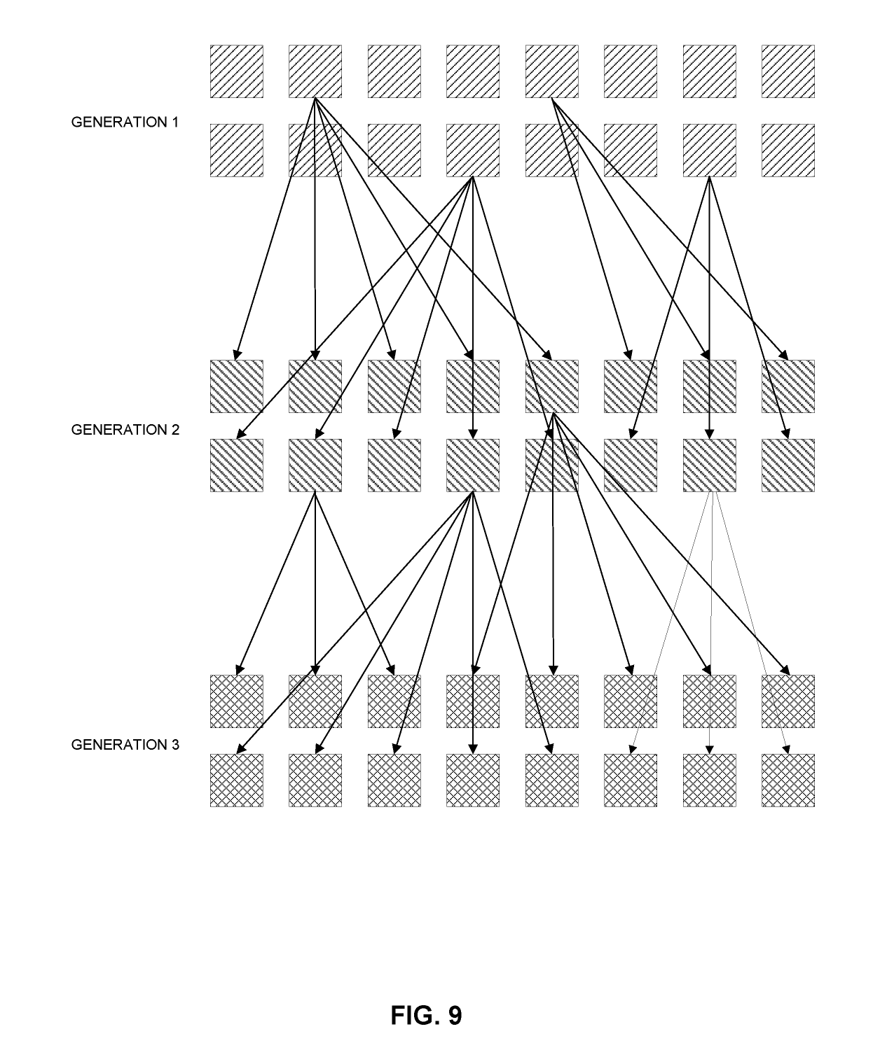

In this manner, multiple generations of candidate web page layouts can be generated. FIG. 9 illustrates this approach. In FIG. 9 a first generation of candidate layouts is depicted. Within those candidate layouts the highest scoring layouts are selected and utilized to generate a second generation of layouts. Then the process repeats with the highest scoring layouts in the second generation being used to generate a third generation of candidate web page layouts.

The present system and method, therefore, provides for the automatic generation of optimized web page layouts for web page content. The system can, without a user input, generate a plurality of candidate web page layouts. Those candidate layouts can then be efficiently populated with rectangles that act as placeholders for actual content. The populated candidate layouts can then be scored and ranked based upon a number of attributes that generally correlate to the effectiveness or attractiveness of web page content. Once scored and ranked, an optimized web page layout can be identified (e.g., the candidate web page layout having the highest score). In some embodiments an iterative process is utilized to identify the optimized web page layout. The iterative process may involve generating multiple generations of candidate web page layouts, where a set of highest scoring candidate layouts from one generation is used to generate the candidate web page layouts in the next generation.

Once identified, the optimized web page layout can be populated with the original web page content and presented to a user. For example, the populated optimized web page layout could be loaded into a website editor or design tool enabling the user to publish the website to a location accessible on the Internet. In some cases, the user may use the website editor or design tool to make adjustments or changes to the web page before it is published to the Internet.

In some cases, rather then provide the user with only a single optimized web page layout, the system may instead generate a larger number of optimized web page layouts (e.g., the ten candidate web page layouts having the highest score). Each of those layouts could then be presented to the user in the form of a “flip-book” or other user interface enabling the user to browse through each of the candidate layouts. The user may then select one of the layouts, which could then be loaded into a web page editor or other tool enabling the user to modify the layout and then publish the web page to the Internet. When presenting a number of layouts for review by the user, the present system may review the group of layouts to ensure that they are sufficiently different from one another to warrant present to the user-if the various layouts only differ by a very small degree (e.g., the columns only different by very small width amounts) it may not be helpful for the user to review a collection of candidate layouts that only differ by a small degree.

As such, when generating the group of layouts, the present system may be configured to ensure that the layouts selected for the groups all differ sufficiently from one another to warrant presentation to the user. This may be achieved by the system applying a small score penalty to other candidate web page layouts that are similar (e.g., similar column numbers, dimensions, and layouts) to the layout currently being displayed to the user. For example, a distance function that compares number of columns, relative widths of columns, and the like, may be used to determine a level of similarity between two candidate web page layouts.

In some embodiments, the present system may be incorporated into a web page editor tool so that as the user makes updates and changes to the content of a web page, the layout of that web page could automatically be updated and adjusted according to the methods of the present claim. For example, a user may use a web page editor to modify the text in one of the text block on the web page. Such a change may cause the current layout to be suboptimal for the current text content. In that case, the web editor may include a user interface enabling the user to cause the web editor to automatically optimize the layout of the web page being edited according to the methods of the present disclosure.

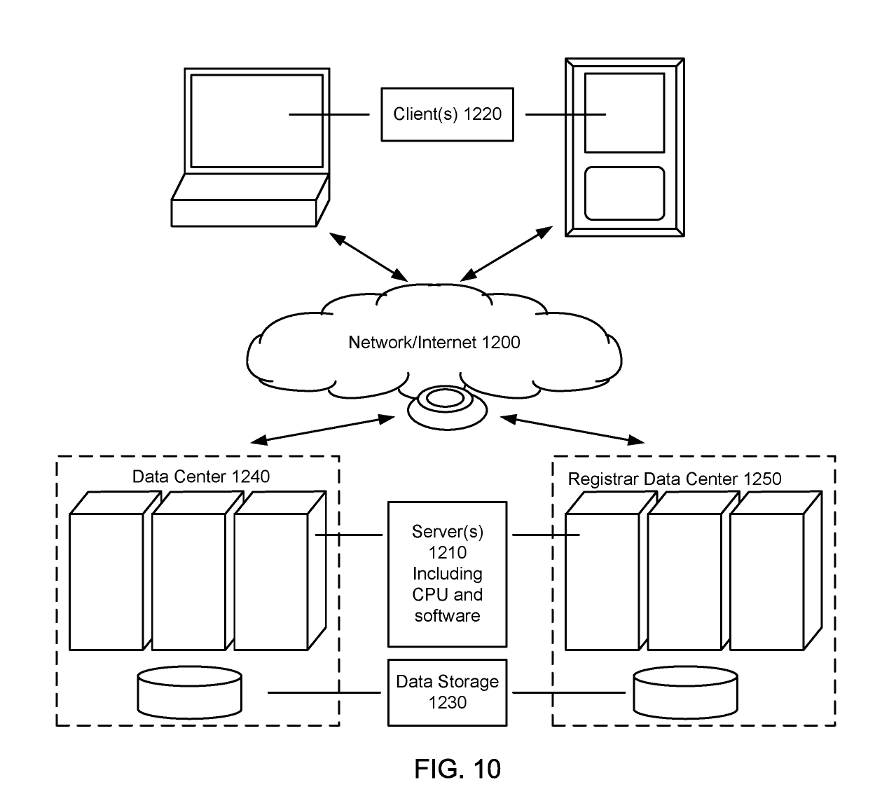

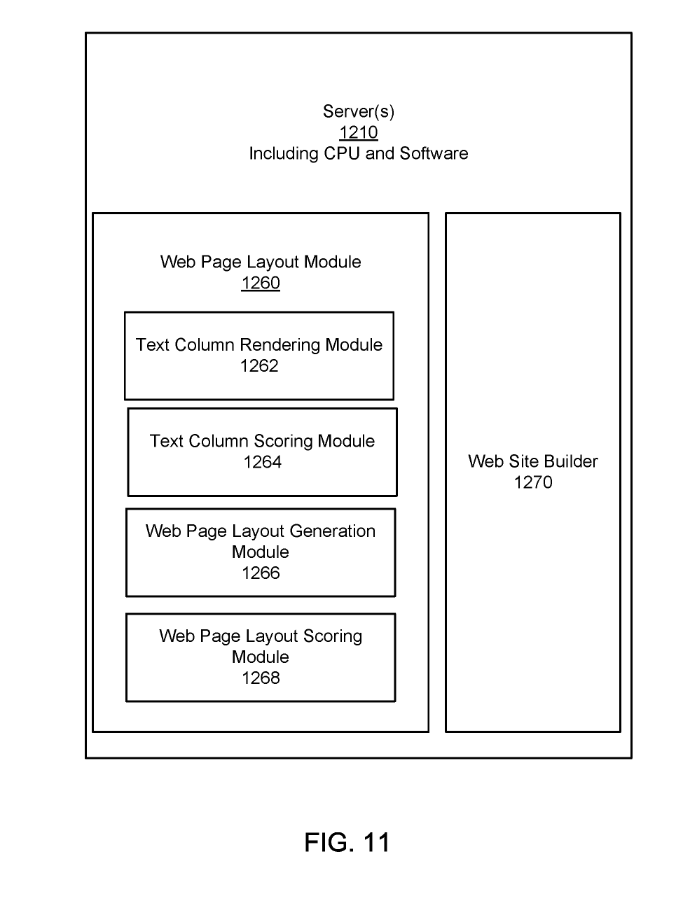

Several different environments may be used to accomplish the steps of embodiments disclosed herein. FIGS. 10 and 11 demonstrate a streamlined example of such an environment and illustrate a non-limiting example of a system and/or structure that may be used to accomplish the methods and embodiments disclosed and described herein. Such methods may be performed by any central processing unit (CPU) in any computing system, such as a microprocessor running on at least one server 1210 and/or client 1220, and executing instructions stored (perhaps as scripts and/or software, possibly as software modules) in computer-readable media accessible to the CPU, such as a hard disk drive on a server 1210 and/or client 1220.

The example embodiments herein place no limitations on whom or what may comprise users. Thus, as non-limiting examples, users may comprise any individual, entity, business, corporation, partnership, organization, governmental entity, and/or educational institution.

The example embodiments shown and described herein exist within the framework of a network 1200 and should not limit possible network configuration or connectivity. Such a network 1200 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

At least one server 1210 and at least one client 1220 may be communicatively coupled to the network 1200 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM),

Infrared Data Association (IrDA), wireless, WAN technologies (T1, Frame Relay), Point-to-Point Protocol over Ethernet (PPPoE), and/or any combination thereof.

The server(s) 1210 and client(s) 1220 (along with software modules and the data storage 1230 disclosed herein) may be communicatively coupled to the network 1200 and to each other in such a way as to allow the exchange of information required to accomplish the method steps disclosed herein, including, but not limited to receiving the information from a user interface on one or more clients 1220, and one or more servers 1210 receiving the information.

The client 1220 may be any computer or program that provides services to other computers, programs, or users either in the same computer or over a computer network 1200. As non-limiting examples, the client 1220 may be an application, communication, mail, database, proxy, fax, file, media, web, peer-to-peer, or standalone computer, cell phone, “smart” phone, personal digital assistant (PDA), etc. which may contain an operating system, a full file system, a plurality of other necessary utilities or applications or any combination thereof on the client 1220. Non limiting example programming environments for client applications may include JavaScript/AJAX (client side automation), ASP, JSP, Ruby on Rails, Python's Django, PHP, HTML pages or rich media like Flash, Flex, Silverlight, any programming environments for mobile “apps,” or any combination thereof.

The client computer(s) 1220 which may be operated by one or more users and may be used to connect to the network 1200 to accomplish the illustrated embodiments may include, but are not limited to, a desktop computer, a laptop computer, a hand held computer, a terminal, a television, a television set top box, a cellular phone, a wireless phone, a wireless hand held device, a “smart” phone, an Internet access device, a rich client, thin client, or any other client functional with a client/server computing architecture. Client software may be used for authenticated remote access to one more hosting computers or servers, described below. These may be, but are not limited to being accessed by a remote desktop program and/or a web browser, as are known in the art.

The user interface displayed on the client(s) 1220 or the server(s) 1210 may be any graphical, textual, scanned and/or auditory information a computer program presents to the user, and the control sequences such as keystrokes, movements of the computer mouse, selections with a touch screen, scanned information etc. used to control the program. Examples of such interfaces include any known or later developed combination of Graphical User Interfaces (GUI) or Web-based user interfaces, including Touch interfaces, Conversational Interface Agents, Live User Interfaces (LUI), Command line interfaces, Non-command user interfaces, Object-oriented User Interfaces (OOUI) or Voice user interfaces. Any information generated by the user, or any other information, may be accepted using any field, widget and/or control used in such interfaces, including but not limited to a text-box, text field, button, hyper-link, list, drop-down list, check-box, radio button, data grid, icon, graphical image, embedded link, etc.

The software modules used in the context of the current invention may be stored in the memory of-and run on-at least one server 1210 and/or client 1220. The software modules may comprise software and/or scripts containing instructions that, when executed by a microprocessor on a server 1210 and/or client 1220, cause the microprocessor to accomplish the purpose of the module or the methods disclosed herein.

The software modules may interact and/or exchange information via an Application Programming Interface or API. An API may be a software-to-software interface that specifies the protocol defining how independent computer programs interact or communicate with each other. The API may allow a requesting party's software to communicate and interact with the software application and/or its provider-perhaps over a network-through a series of function calls (requests for services). It may comprise an interface provided by the software application and/or its provider to support function calls made of the software application by other computer programs, perhaps those utilized by the requesting party to provide information for publishing or posting domain name and hosted website information.

The server(s) 1210 utilized within the disclosed system may comprise any computer or program that provides services to other computers, programs, or users either in the same computer or over a computer network 1200. The server 1210 may exist within a server cluster, as illustrated. These clusters may include a group of tightly coupled computers that work together so that in many respects they can be viewed as though they are a single computer. The components may be connected to each other through fast local area networks which may improve performance and/or availability over that provided by a single computer.

The server(s) 1210 or software modules within the server(s) 1210 may use query languages such as Postgre MySQL to retrieve the content from data storage 1230. Server-side scripting languages such as ASP, PHP, CGI/Perl, proprietary scripting software/modules/components etc. may be used to process the retrieved data. The retrieved data may be analyzed in order to determine information recognized by the scripting language, information to be matched to those found in data storage, availability of requested information, comparisons to information displayed and input/selected from the user interface or any other content retrieval within the method steps disclosed herein.

The server 1210 and/or client 1220 may be communicatively coupled to data storage 1230 to retrieve any information requested. The data storage 1230 may be any computer components, devices, and/or recording media that may retain digital data used for computing for some interval of time. The storage may be capable of retaining stored content for any data requested, on a single machine or in a cluster of computers over the network 1200, in separate memory areas of the same machine such as different hard drives, or in separate partitions within the same hard drive, such as a database partition.

Non-limiting examples of the data storage 1230 may include, but are not limited to, a Network Area Storage, (“NAS”), which may be a self-contained file level computer data storage connected to and supplying a computer network with file-based data storage services. The storage subsystem may also be a Storage Area Network (“SAN”—an architecture to attach remote computer storage devices to servers in such a way that the devices appear as locally attached), an NAS-SAN hybrid, any other means of central/shared storage now known or later developed or any combination thereof.

The server(s) 1210 and data storage 1230 may exist and/or be hosted in one or more data centers (1240, 1250). These data centers 1240/1250 may provide hosting services for websites, services or software relating to stored information, or any related hosted website including, but not limited to hosting one or more computers or servers in a data center 1240/1250 as well as providing the general infrastructure necessary to offer hosting services to Internet users including hardware, software, Internet web sites, hosting servers, and electronic communication means necessary to connect multiple computers and/or servers to the Internet or any other network 1200. These data centers 1240/1250 or the related clients 1220 may accept messages from text messages, SMS, web, mobile web, instant message, third party API projects or other third party applications.

The system also may comprise a web page layout module 1260 that may be stored in the memory of—and run on—at least one server 1210 and may comprise any software and/or scripts containing instructions that, when executed by the server's 1210 microprocessor, cause the microprocessor to process and analyze candidate web page layouts using one or more of the methods described herein. As illustrated in FIG. 11, the web page layout module 1260 may comprise a text column rendering module 1262, text column scoring module 1264, web page layout generation module 1266, and web page layout scoring module 1268.

Text column rendering module 1262 may comprise scripts and/or software running on the server 1210 that operates to process blocks of input text and generate multiple corresponding columns of rendered text. Once the rendered columns of text are generated, text column scoring module 1264 is configured to execute scripts and/or software running on the server 1210 to analyze the resulting rendered columns of text and allocate each rendered column a score. As such, text column rendering module 1262 and text column scoring module 1264 may be configured, for example, to execute a method such as that illustrated in FIG. 2 and described above.

Web page layout generation module 1266 may comprise scripts and/or software running on the server 1210 that operates to generate candidate web page layouts and populate those candidate layouts with rectangles having the same dimensions as those of the columns of text generated by text column rendering module 1262. Once the populated candidate layouts are generated, web page layout scoring module 1268 is configured to execute scripts and/or software running on the server 1210 to analyze the resulting populated layouts and allocate each populated layout a score. For example, web page layout generation module 1266 and web page layout scoring module 1268 may be configured, for example, to execute a method such as that illustrated in FIG. 5.

In some embodiments, once a candidate web page layout having a highest score is identified (e.g., via scores generated by web page layout scoring module 1268), the candidate web page layout having the highest score can be populated with the original web page content (e.g., the rectangle place holders can be replaced by the original text content). After being populated with the original web page text content, the resulting web page layout can be imported into another application, such as web site builder application 1270. The web site builder application 1270 may comprise scripts and/or software running on the server 1210 that operates to provide a user with an interface enabling to the user to create new web site content or revise the web page layout.

In various implementations the present methods may be implemented by computing devices, such as server computers, desktop or portable computers, mobile devices, distributed computing services, and the like. The devices may request web pages using any electronic communication medium, communication protocol, and computer software suitable for transmission of data over the Internet. Examples include, respectively and without limitation: a wired connection, WiFi or other wireless network, cellular network, or satellite network; Transmission Control Protocol and Internet Protocol (“TCP/IP”), Global System for mobile Communications (“GSM”) protocols, code division multiple access (“CDMA”) protocols, and Long Term Evolution (“LTE”) mobile phone protocols; and web browsers such as MICROSOFT INTERNET EXPLORER, MOZILLA FIREFOX, and APPLE SAFARI.

In one implementation, a system includes a memory storing a plurality of blocks of text for a web page of a website and a computer server configured to retrieve the plurality of blocks of text for the web page from the memory, and render each block of text in the plurality of blocks of text into a plurality of columns of text. Each column of text in the plurality of columns of text for each block of text has a different width. The computer server is configured to calculate, without user input, a presentation score for each column of text in the plurality of columns of text, and generate a plurality of populated web page layouts for each web page layout in a plurality of web page layouts by determining a number of columns in the web page layout, for each block of text in the plurality of blocks of text, positioning a rectangle having the same width and height as one of the plurality of columns of text for each block of text into a column in the web page layout to generate a populated web page layout, and calculating, without user input, a rendering score for the populated web page layout. The computer server is configured to use one of the plurality of populated web page layouts to render a web page including the blocks of text for the web page.

In another embodiment, a method includes retrieving a plurality of blocks of text for a web page from a memory, and rendering each block of text in the plurality of blocks of text into a plurality of columns of text. Each column of text in the plurality of columns of text for each block of text has a different width. The method includes calculating, without user input, a presentation score for each column of text in the plurality of columns of text, and generating a plurality of populated web page layouts for each web page layout in a plurality of web page layouts by determining a number of columns in the web page layout, for each block of text in the plurality of blocks of text, positioning a rectangle having the same width and height as one of the plurality of columns of text for each block of text into a column in the web page layout to generate a populated web page layout, and calculating, without user input, a rendering score for the populated web page layout. The method includes using one of the plurality of populated web page layouts to render a web page including the blocks of text for the web page.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As a non-limiting example, the steps described above (and all methods described herein) may be performed by any central processing unit (CPU) or processor in a computer or computing system, such as a microprocessor running on a server computer, and executing instructions stored (perhaps as applications, scripts, apps, and/or other software) in computer-readable media accessible to the CPU or processor, such as a hard disk drive on a server computer, which may be communicatively coupled to a network (including the Internet). Such software may include server-side software, client-side software, browser-implemented software (e.g., a browser plugin), and other software configurations.

The present invention has been described in terms of one or more preferred embodiments, and it should be appreciated that many equivalents, alternatives, variations, and modifications, aside from those expressly stated, are possible and within the scope of the invention.

We claim:

1. A system, comprising:
a memory storing a plurality of blocks of text for a web page of a website; and
a computer server configured to:
retrieve the plurality of blocks of text for the web page from the memory,
render each block of text in the plurality of blocks of text into a plurality of columns of text, each column of text in the plurality of columns of text for each block of text having a different width,
calculate, without user input, a presentation score for each column of text in the plurality of columns of text,
generate a plurality of populated web page layouts for each web page layout in a plurality of web page layouts by:
determining a number of columns in the web page layout,
for each block of text in the plurality of blocks of text, positioning a rectangle having the same width and height as one of the plurality of columns of text for each block of text into a column in the web page layout to generate a populated web page layout, and
calculating, without user input, a rendering score for the populated web page layout; and
use one of the plurality of populated web page layouts to render a web page including the blocks of text for the web page.

2. The system of claim 1, wherein calculating, without user input, the presentation score for each column of text includes:
determining an amount of whitespace in each column of text; and
determining whether a hanging word is located within each column of text.

3. The system of claim 2, wherein determining whether a hanging word is located within each column of text includes determining whether a last line of text in the column of text includes a single word.

4. The system of claim 1, wherein the blocks of text are delineated by a hypertext markup language tag stored in the memory.

5. The system of claim 1, wherein using one of the plurality of populated web page layouts to render a web page including the blocks of text for the web page includes using the populated web page layout having a highest rendering score in the plurality of populated web page layouts to render a website including the blocks of text for the web page.

6. The system of claim 1, wherein the computer server is configured to:
generate a user interface depicting at least two of the populated web page layouts and enabling a user to select one of the at least two of the populated web page layouts.

7. The system of claim 1, wherein the computer server includes a machine learning engine configured to calculate, without user input, the rendering score for the populated web page layout.

8. The system of claim 1, wherein calculating, without user input, the rendering score for the populated web page layout includes determining a distance between at least two rectangles in the populated web page layout.

9. The system of claim 1, wherein calculating, without user input, the rendering score for the populated web page layout includes determining a symmetry score for the populated web page layout.

10. The system of claim 1, wherein the computer sever is configured to, after generating a plurality of populated web page layouts, generate a second plurality of populated web page layouts using a populated web page layout having a highest rendering score.

11. A method, comprising:
retrieving a plurality of blocks of text for a web page from a memory;
rendering each block of text in the plurality of blocks of text into a plurality of columns of text, each column of text in the plurality of columns of text for each block of text having a different width;
calculating, without user input, a presentation score for each column of text in the plurality of columns of text;
generating a plurality of populated web page layouts for each web page layout in a plurality of web page layouts by:
determining a number of columns in the web page layout,
for each block of text in the plurality of blocks of text, positioning a rectangle having the same width and height as one of the plurality of columns of text for each block of text into a column in the web page layout to generate a populated web page layout, and
calculating, without user input, a rendering score for the populated web page layout; and
using one of the plurality of populated web page layouts to render a web page including the blocks of text for the web page.

12. The method of claim 11, wherein calculating, without user input, the presentation score for each column of text includes:
determining an amount of whitespace in each column of text; and
determining whether a hanging word is located within each column of text.

13. The method of claim 12, wherein determining whether a hanging word is located within each column of text includes determining whether a last line of text in the column of text includes a single word.

14. The method of claim 11, wherein the blocks of text are delineated by a hypertext markup language tag stored in the memory.

15. The method of claim 11, wherein using one of the plurality of populated web page layouts to render a web page including the blocks of text for the web page includes using the populated web page layout having a highest rendering score in the plurality of populated web page layouts to render a website including the blocks of text for the web page.

16. The method of claim 11, including generating a user interface depicting at least two of the populated web page layouts and enabling a user to select one of the at least two of the populated web page layouts.

17. The method of claim 11, including using a machine learning engine to calculate, without user input, the rendering score for the populated web page layout.

18. The method of claim 11, wherein calculating, without user input, the rendering score for the populated web page layout includes determining a distance between at least two rectangles in the populated web page layout.

19. The method of claim 11, wherein calculating, without user input, the rendering score for the populated web page layout includes determining a symmetry score for the populated web page layout.

20. The method of claim 11, including, after generating a plurality of populated web page layouts, generate a second plurality of populated web page layouts using a populated web page layout having a highest rendering score.
